(19) United States
(12) Patent Application Publication
(10) Pub. No.: US 2005/0121237 A1
(43) Pub. Date: Jun. 9, 2005

(54) Weight measuring device

(75) Inventor: Tetsuro Kusumoto, Uji-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: SHIMADZU CORPORATION

(21) Appl. No.: 10/923,899

(22) Filed: Aug. 24, 2004

(30) Foreign Application Priority Data
Nov. 17, 2003 (JP) 2003-386082

(51) Int. Cl. H01H 67/02; G01G 3/08

(52) U.S. Cl. 177/229

(57) ABSTRACT

A weight measuring device includes a force measuring cell formed of a Roberval mechanism having a movable pole, a fixed pole, and two parallel beams connecting the movable pole and the fixed pole. At least one of the movable pole and the fixed pole has a plurality of holes formed in a thickness direction thereof. Adaptors are attached to two sides of the one of the movable pole and the fixed pole in the thickness direction. Bolts pass through the holes and the adaptors and are tightened with nuts. At least one of the bolts passes thorough the hole in a direction opposite to that of the other of the bolts. A receptacle plate is attached to the movable pole for supporting a plate for placing the weight thereon.

### BACKGROUND OF THE INVENTION AND RELATED ART STATEMENT

The present invention relates to a weight measuring device such as an electro-balance and, more particularly, relates to a weight measuring device including a Roberval mechanism formed by boring a plate of a raw material in a thickness direction.

In an electro-balance of so-called an electromagnetic force balance type, a weight to be measured is balanced with an electromagnetic force. Such an electro-balance generally includes an electromagnetic force generator wherein a movable coil is disposed in a static magnetic field formed by a magnetic circuit, and the movable coil is attached to one end of a lever engaging a receptacle plate. A detector detects a displacement of the lever when the weight to be measured is loaded on the receptacle plate. A current passing through the movable coil of the electromagnetic force generator is controlled through a feedback control so that the detected displacement becomes zero. Accordingly, the weight to be measured is determined from the current required for making the displacement of the lever zero.

A Roberval mechanism generally supports the receptacle plate such that the displacement of the receptacle plate is limited only in a vertical direction, thereby eliminating a deviation in a position. The Roberval mechanism includes a fixed pole and a movable pole connected through upper and lower beams extending in parallel and having end portions provided with flexible members. The receptacle plate is attached to the movable pole, and the movable pole and a lever are connected by a flexible connecting member.

Conventionally, there has been known an electro-balance using a block mechanical structure as a force measuring cell in which a plate of a raw material is bored in a thickness direction to form a Roberval mechanism, a lever mechanism, and a connecting member for connecting these mechanisms (for example, refer to Japanese Patent Publication (Kokai) No. 63-277936).

FIG. 6 is a vertical sectional view showing a structure of an electro-balance of the electromagnetic force balance type disclosed in Japanese Patent Publication (Kokai) No. 63-277936. As shown FIG. 6, a Roberval mechanism 61 has a structure wherein a fixed pole 611 and a movable pole 612 are connected through upper and lower beams 613a and 631b extending in parallel. The Roberval mechanism 61, a lever mechanism 62 and a connecting portion 63 are integrally formed in a block-shape mechanical structure 60 by boring a plate of a raw material in a thickness direction.

In the electro-balance, the lever mechanism 62 is formed of a lever main portion 621 and an elastic supporting point 622, and has one end fixed to a movable coil 64a of an electromagnetic force generator 64. The electromagnetic force generator 64 is formed of the movable coil 64a and a magnetic circuit 64c including a permanent magnet 64b for forming a static magnetic field where the movable coil 64a is positioned. The electromagnetic force generator 64 generates electromagnetic force corresponding to a current passing through the movable coil 64a.

When the block-shape mechanical structure 60 is assembled to the electro-balance, female screws are formed in an outer end surface of the fixed pole 611 of the Roberval mechanism 61, and screws S are screwed into the females screws through a base member 65 of the electro-balance, so that the block-shape mechanical structure 60 is fixed to the base member 65. A receptacle plate 67 supports a plate 66 for placing an article to be measured, and is integrated with a male screw 67a. The male screw 67a is screwed into a female screw formed in a top portion of the movable pole 612, so that the receptacle plate 67 is fixed thereto.

In an electro-balance of a load cell type, a strain member constituting an essential part of a load cell is generally formed of a block-shape Roberval mechanism formed by boring a sheet-shape member (for example, refer to Japanese Patent Publication (Kokai) No. 07-35601).

In the load cell type balance disclosed in Japanese Patent Publication (Kokai) No. 07-35601, as shown in FIG. 7, a Roberval mechanical structure 70 is formed by boring a sheet of a raw material, and includes a fixed pole 71 and a movable pole 72 connected through parallel upper and lower beams 73a and 73b. Flexible portions (strain portions) e are provided in the vicinity of both end portions of the upper and lower beams 73a and 73b of the Roberval mechanical structure 70, and strain gauges (not shown) are attached to the flexible portions to form a load cell as the force measuring cell.

When the Roberval mechanical structure 70 is assembled to the electro-balance, female screws are formed in an outer end surface of the fixed pole 71 of the Roberval mechanical structure 70, and a fixing adaptor 74 is fixed with screws S, so that the fixing adaptor 74 is fixed to a base member 75. In order to attach a receptacle plate 76 to the movable pole 72, female screws are formed in an outer end surface of the movable pole 72, and an attaching adaptor 77 is fixed with screws S, so that the receptacle plate 76 is fixed to the attaching adaptor 77.

In the conventional fixing structure of the block-shape mechanical structure 60 to the base member 65 of the balance or the receptacle plate 67 to the movable pole shown in FIG. 6, the female screws are formed in the fixed pole 611 or the movable pole 612 of the Roberval mechanism 61 in a direction perpendicular to the thickness direction. A bolt B or the male screw 67a integrated with the receptacle plate 67 is directly screwed into the female screw to assemble the respective members. Accordingly, when the flexible portions e formed on the end portions of the respective beams 613a and 613b of the Roberval mechanism 61 of the block-shape mechanical structure 60, an elastic supporting point 62b of the lever mechanism 62, or the flexible portions e of the connecting portion 63 are minimized, the bolt or the male screw 67a generates a strain in these portions upon screwing-in, thereby lowering measurement accuracy. The conventional load cell type balance shown in FIG. 7 has the same problem.

In order to solve the problem described above, a structure shown in FIGS. 8 and 9 has been proposed by the applicant, which is disclosed in Japanese Patent Application No. 2002-184308 filed on Jun. 25, 2002 (Japanese Patent Publication (KOKAI) No. 2004-28750 published on Jan. 29, 2004). The structure shown in FIGS. 8 and 9 is a former invention, but not prior art for the present invention.

FIG. 8 is a front view of an essential part of the structure, and FIG. 9 is a plan view thereof. As shown in FIGS. 8 and 9, a block-shape mechanical structure 80 is integrally formed of a Roberval mechanism 81, a lever mechanism 82, and a connecting portion 83. In the structure, a plurality of through holes H is formed in a fixed pole 811 of the Roberval mechanism 81 of the block-shape mechanical structure 80 in a thickness direction thereof. Fixing adaptors 88a and 88b are attached to both sides of the fixed pole 811 in a thickness direction thereof. Nuts N are tightened to bolts B passing through the fixing adaptors 88a and 88b and the through holes H, so that the fixing adaptors 88a and 88b are integrated with the block-shape mechanical structure 80. The fixing adaptors 88a and 88b are then screwed in the base member 85 of the balance.

In order to attached a receptacle plate 87 to a movable pole 812, a plurality of through holes H is formed in the movable pole 812 in the thickness direction of the block-shape mechanical structure 80, and attaching adaptors 89a and 89b are closely attached to both sides of the movable pole 812 in a thickness direction thereof. Nuts N are tightened to bolts B passing through the attaching adaptors 89a and 89b and the through holes H, so that the attaching adaptors 89a and 89b are integrated with the movable pole 812. Then, the receptacle plate 87 is screwed in the attaching adaptors 89a and 89b.

With the structure described above, when the fixed pole 811 is fixed to the fixing member 85 of the balance or the receptacle plate 87 is fixed to the movable pole 812, it is possible to reduce a strain in the block-shape mechanical structure 80 due to screwing of the bolts B, thereby obtaining high accuracy. Also, the structure can be applied to the load cell type balance shown in FIG. 7.

However, in the structure described above, the nuts N are tightened to the bolts B passing through the through holes H of the fixed pole 811 and the movable pole 812 in a horizontal posture with torque in a same direction. Accordingly, when moment such as load of a weight is repeatedly applied in a direction opposite to the torque, there is a possibility that the bolts B are loosen from the nuts N.

In view of the problems described above, the present invention has been made, and an object of the invention is to provide a weight measuring device such as an electro-balance and the like, wherein it is possible to reduce a strain in a block-shape mechanical structure due to fixing the block-shape mechanical structure to a base member or a receptacle plate to a movable pole. Further, it is possible to prevent a tightening portion of a fixing portion or an attaching portion from loosening without a special bolt and the like.

Further objects and advantages of the invention will be apparent from the following description of the invention.

### SUMMARY OF THE INVENTION

In order to attain the objects described above, according to a first aspect of the present invention, a weight measuring device includes a force measuring cell formed of a Roberval mechanism having a movable pole and a fixed pole connected through two parallel beams. The Roberval mechanism is a block-shape mechanical structure formed by boring a plate of a raw material in a thickness direction. The fixed pole is fixed to a base member through fixing adaptors. A receptacle plate supports a plate for placing an article to be measured thereon, and is directly or indirectly attached to the movable pole. The fixing adaptors have a shape to be closely attached to both sides of the fixed pole in a thickness direction, respectively. A plurality of through holes is formed in the fixed pole in a thickness direction of the raw material. Bolts pass through the through holes and the fixing adaptors, and nuts are tightened to forward ends of the bolts to fix the fixed pole to the fixing adaptors. A same number of the bolts are arranged in opposite directions, respectively.

According to a second aspect of the invention, a weight measuring device includes a force measuring cell formed of a Roberval mechanism having a movable pole and a fixed pole connected through two parallel beams. The Roberval mechanism is a block-shape mechanical structure formed by boring a plate of a raw material in a thickness direction. The fixed pole is fixed to a base member through fixing adaptors. A receptacle plate supports a plate for placing an article to be measured thereon, and is directly or indirectly attached to the movable pole. The fixing adaptors have a shape to be closely attached to both sides of the fixed pole in a thickness direction, respectively. Female screws are formed in both sides of the fixed pole in a thickness direction, and bolts passing through the fixing adaptors are screwed in the female screws in the both sides, so that the fixed pole is fixed to the fixing adaptors.

According to a third aspect of the present invention, a weight measuring device includes a force measuring cell formed of a Roberval mechanism having a movable pole and a fixed pole connected through two parallel beams. The Roberval mechanism is a block-shape mechanical structure formed by boring a plate of a raw material in a thickness direction. A fixed pole is directly or indirectly fixed to a base member. A receptacle plate supports a plate for placing an article to be measured thereon, and is attached to a movable pole through fixing adaptors. The fixing adaptors have a shape to be closely attached to both sides of a movable pole in a thickness direction, respectively. A plurality of through holes is formed in the movable pole in the thickness direction. Bolts pass through the through holes and the fixing adaptors, and nuts are tightened to forward ends of the bolts to fix the fixing adaptors to the movable pole. A same number of the bolts are arranged in opposite directions, respectively.

According to a fourth aspect of the invention, a weight measuring device includes a force measuring cell formed of a Roberval mechanism having a movable pole and a fixed pole connected through two parallel beams. The Roberval mechanism is a block-shape mechanical structure formed by boring a plate of a raw material in a thickness direction. The fixed pole is directly or indirectly fixed to a base member. A receptacle plate supports a plate for placing an article to be measured thereon, and is attached to the movable pole through fixing adaptors. The fixing adaptors have a shape to be closely attached to both sides of the movable pole in a thickness direction, respectively. Female screws are formed in both sides of the movable pole in a thickness direction, and bolts passing through the fixing adaptors are screwed in the female screws in the both sides, so that the fixing adaptors is fixed to the movable pole.

In the present invention, a plurality of the through holes or female screws is formed in the block-shape mechanical structure in the thickness direction. The adaptors are attached by the bolts passing through the through holes or screwed in the female screws, so that the fixed pole is fixed to the base member or the receptacle plate is attached to the movable pole through the adaptors. Accordingly, it is possible to reduce a strain in the block-shape mechanical structure due to tightening of the bolts. Further, the bolts are screwed in or pass through in the opposite directions, so that loosening of a tightening portion due to torque action is prevented.

The first and second aspects are directed to a structure of fixing the fixed pole to the base member. In the first aspect, a plurality of the through holes is formed in the fixed pole in the thickness direction. The fixing adaptors closely attached to both sides of the fixed pole in the thickness direction are tightened by the nuts and bolts passing through the through holes, so that the fixing adaptors are fixed to the base member. Accordingly, it is possible to reduce a strain in the block-shape mechanical structure due to the tightening. Further, the bolts are inserted in the opposite directions to have tightening torques in the opposite directions. Accordingly, even when torque is repeatedly applied in a specific direction, it is possible to prevent the tightening portions of the bolts from loosening.

The third aspect is directed to a structure of attaching the receptacle plate to the movable pole to obtain an advantage same as that of the first aspect. That is, a plurality of the through holes is formed in the movable pole in the thickness direction. The attaching adaptors for attaching the receptacle plate are closely attached on both sides of the movable pole in the thickness direction. A plurality of the bolts passes through the through holes and the attaching adaptors. The bolts are inserted in the opposite directions. Accordingly, it is possible to reduce a strain in the block-shape mechanical structure due to the tightening. Further, even when torque is repeatedly applied to the tightening portions in the same direction, it is possible to prevent the tightening portions of the bolts from loosening.

The second aspect employs the fixing adaptors same as those in the first aspect. The female screws formed in the both sides of the fixed pole in the thickness direction, and the fixing adaptors are attached by screwing the bolts passing through the fixing adaptors into the female screws. With the structure, the bolts are directly screwed in the fixed pole in the thickness direction. Accordingly, as compared with a conventional structure in which bolts are screwed in a direction perpendicular to the thickness direction, it is possible to reduce a strain in the block-shape mechanical structure due to bolt screwing. Further, the bolts are inserted from both sides in the thickness direction. Accordingly, even when torque is repeatedly applied to the tightening portions of the bolts in the same direction, it is possible to prevent the tightening portions of the bolts from loosening.

The fourth aspect is directed to a structure of attaching the receptacle plate to the movable pole to obtain an advantage same as that of the second aspect, and employs the same attaching adaptors as those in the third aspect. The female screws are formed in the both sides of the movable pole in the thickness direction, and the attaching adaptors are attached to the movable pole by screwing the bolts passing through the attaching adaptors into the female screws. Accordingly, it is possible to reduce a strain in the block-shape mechanical structure due to the screwing of the bolts, and prevent the tightening portions from loosening.

In the first and second aspects of the present invention, when the bolts are tightened for fixing the fixed pole to the base member, it is possible to reduce a strain in the block-shape mechanical structure and prevent the tightening portions from loosening. In the third and the fourth aspects of the present invention, when the bolts are tightened for attaching the receptacle plate to the movable pole, it is possible to reduce a strain in the block-shape mechanical structure and prevent the tightening portions from loosening.

### BRIEF DESCRIPTION OF THE DRAWINGS

FIG. 1 is a front view showing an essential part of a weight measure device according to an embodiment of the present invention;

FIG. 2 is a plan view thereof;

FIG. 3 is a right side view thereof;

FIG. 4 is a plan view of an essential part of a weight measure device according to another embodiment of the present invention;

FIG. 5 is a right side view thereof;

FIG. 6 is a vertical sectional view showing a conventional electromagnetic type electro-balance;

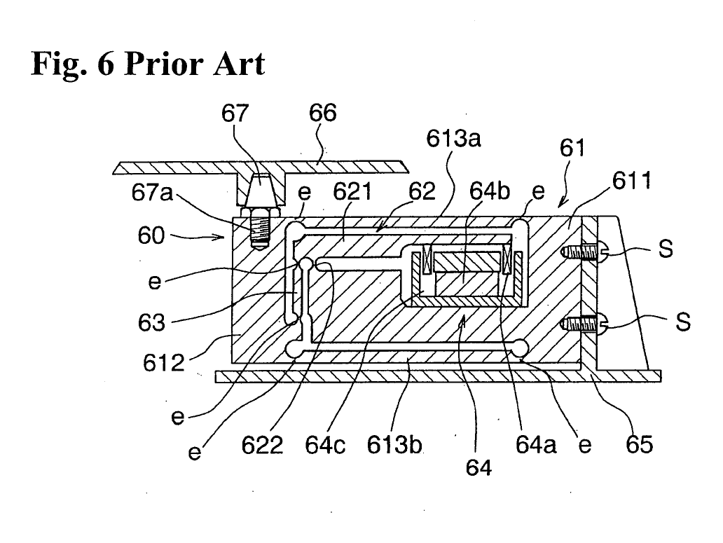

FIG. 7 is a front view showing a structure of a conventional load cell type electro-balance;

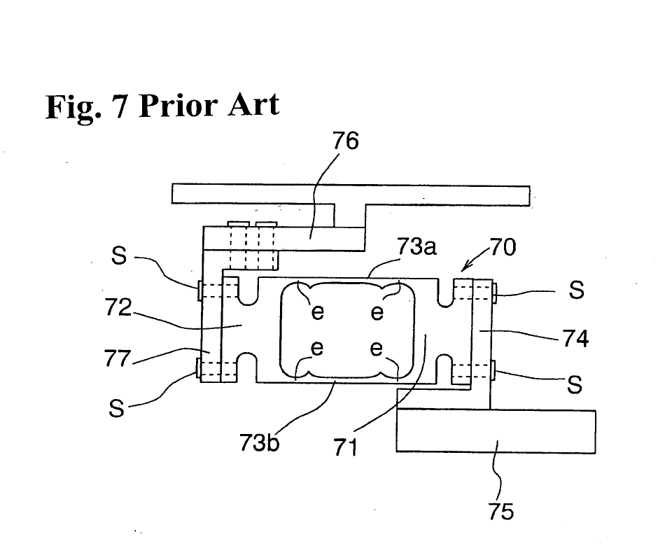

FIG. 8 is a front view of a former invention showing an essential part of a structure for reducing a strain in a block-shape mechanical structure due to fixing of a fixed pole to a base member or attaching a receptacle plate to a movable pole; and

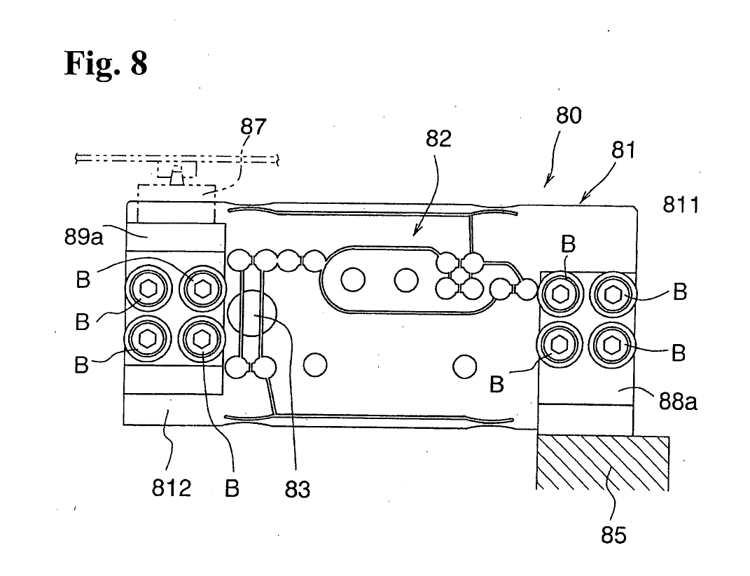

FIG. 9 is a plan view of the structure shown in FIG. 8.

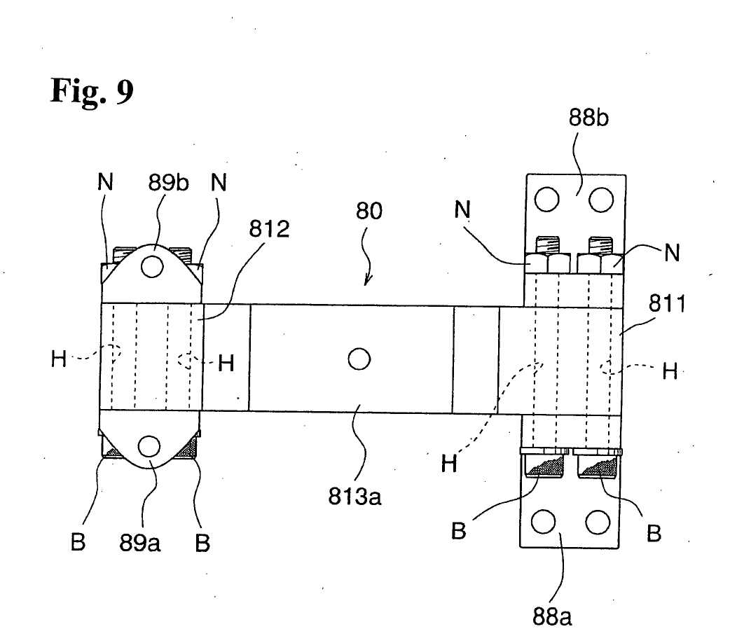

### DETAILED DESCRIPTION OF PREFERRED EMBODIMENT

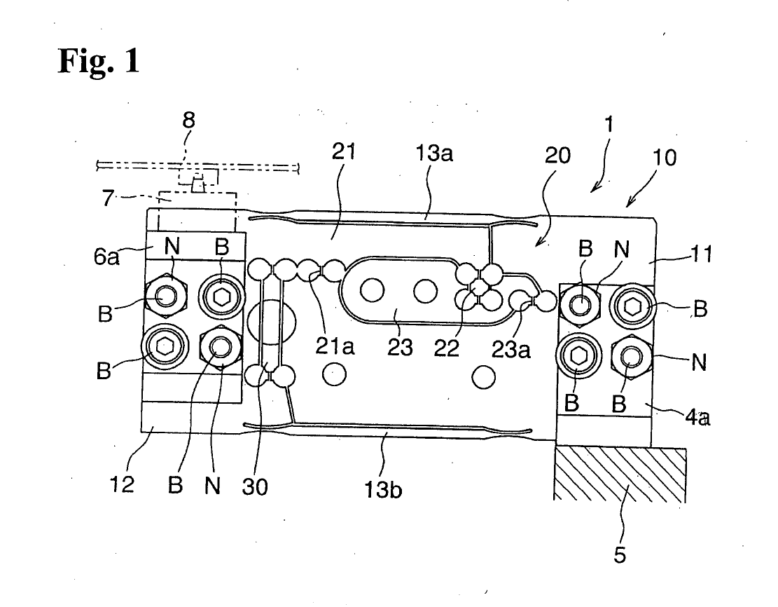

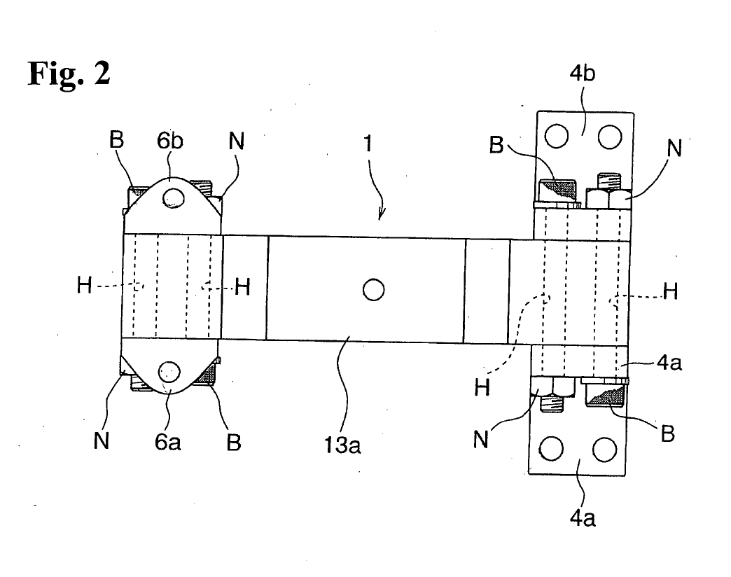

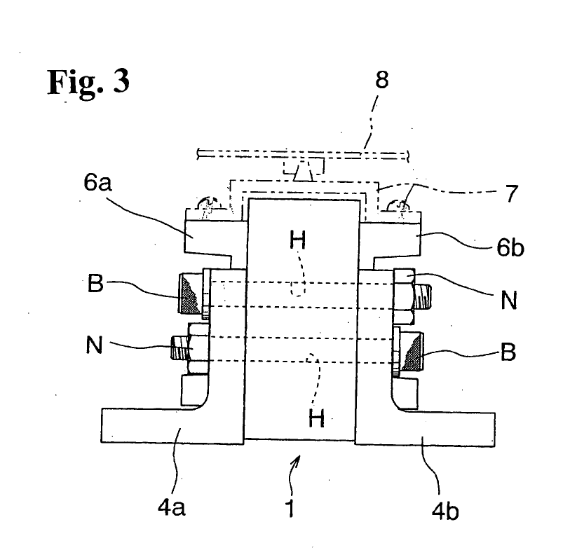

Hereunder, embodiments according to the present invention will be explained in detail with reference to the accompanying drawings. FIG. 1 is a front view showing an essential part of a weight measure device according to an embodiment of the present invention. FIG. 2 is a plan view thereof, and FIG. 3 is a right side view thereof.

A block-shape mechanical structure 1 is formed by boring a plate of a raw material, and includes a Roberval mechanism 10 formed of a fixed pole 11 and a movable pole 12 connected with parallel two upper and lower beams 13a and 13b; a lever mechanism 20 with two stages; and a connecting portion 30 connecting the lever mechanism 20 and the movable pole 12.

The lever mechanism 20 is formed of a first lever main portion 21 connected to the movable pole 12 through the connecting portion 30 and an elastic supporting point 21a thereof; and a second lever main portion 23 connected to the first lever main portion 21 through a connecting portion 22 and an elastic supporting point 23a thereof. The second lever main portion 23 is fixed to one end of a corbelling member (not shown), and a movable coil of an electromagnetic force generating device (both not shown) is fixed to the other end of the corbelling member.

The fixed pole 11 includes four through holes H disposed in a thickness direction, and fixing adaptors 4a and 4b with an L shape section are closely fixed on both sides thereof in the thickness direction. The fixing adaptors 4a and 4b are provided with four through holes corresponding to the through holes H formed in the fixed pole 11. In a state that the through holes of the fixing adaptors 4a and 4b correspond to the through holes H of the fixed pole 11, four bolts B are inserted in opposites directions, i.e. two in on direction and two in the other direction, so that the bolts pass through the through holes of both members. Then, nuts N are tightened to forward ends of the bolts B to thereby fix the fixing adaptors 4a and 4b to the fixed pole 11. The fixing adaptors 4a and 4b are fixed to a base member 5 with bolts, so that the fixed pole 11 of the block-shape mechanical structure 1 is indirectly fixed to the base member 5.

The movable pole 12 is provided with four through holes H in a thickness direction, and attaching adaptors 6a and 6b are closely fixed on both sides of the movable pole 12 in the thickness direction. The attaching adaptors 6a and 6b are provided with four through holes corresponding to the through holes H formed in the movable pole 12. In a state that the through holes of the attaching adaptors 6a and 6b correspond to the through holes H of the movable pole 12, four bolts B are inserted in opposites directions, i.e. two in one direction and two in the other direction, so that the bolts pass through the through holes of both members. Then, nuts N are tightened to forward ends of the bolts B to thereby fix the attaching adaptors 6a and 6b to the movable pole 12. As shown in FIG. 3, a receptacle plate 7 is fixed to the attaching adaptors 6a and 6b over the block-shape mechanical structure 1 with bolts, so that the receptacle plate 7 is fixed to the movable pole 12. Incidentally, a plate 8 is supported on the receptacle plate 7.

According to the embodiment described above, the fixing adaptors 4a and 4b are fixed to the fixed pole 11 for fixing the fixed pole 11 to the base member 5, and the attaching adaptors 6a and 6b are attached to the movable pole 12 for attaching the receptacle plate 7 to the movable pole 12 by tightening the nuts N to the bolts B passing through the through holes H formed in the block-shape mechanical structure 1 in the thickness direction, respectively. Accordingly, it is possible to reduce a strain in various parts of the block-shape mechanical structure 1 due to tightening of the nuts N to the bolts B. Moreover, since the bolts B are inserted in the reverse directions two by two, no loosening is generated by a torque action in any direction.

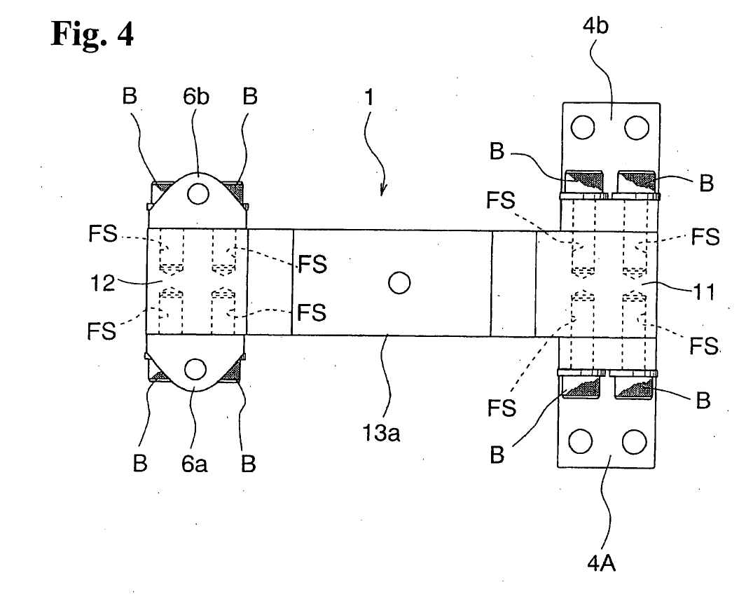

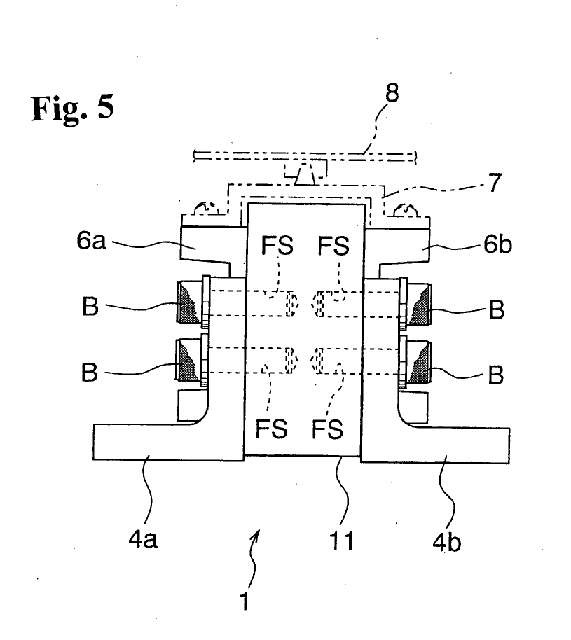

Another embodiment according to the present invention will be explained next. FIG. 4 is a plan view showing an essential part, and FIG. 5 is a right side view thereof. Incidentally, in the embodiment, since the basic structure of the block-shape mechanical structure 1 is the same as that in the previous embodiment, the detailed explanation thereof and the front view are omitted.

In the second embodiment, four female screws FS are formed in both sides of the fixed pole 11 and the movable pole 12 in the thickness direction, and bolts B are screwed in the female screws FS, so that the fixing adaptors 4a and 4b and attaching adaptors 6a and 6b same as those in the first embodiment are fixed to the fixed pole 11 and the movable pole 12, respectively. That is, as in the first embodiment, the fixing adaptors 4a and 4b are provided with through holes corresponding to the four female screws FS formed in both sides of the fixed pole 11 in the thickness direction. The bolts B pass through the through holes and are screwed in the female screws FS in a state that the through holes are aligned with the female screws FS, so that the fixing adaptors 4a and 4b are fixed to the fixed pole 11.

Also, as in the first embodiment, the attaching adaptors 6a and 6b are provided with through holes corresponding to the four female screws FS formed in both sides of the movable pole 12 in the thickness direction. The bolts B pass through the through holes and screwed in the female screws FS in a state the through holes are aligned with the female screws FS, so that the attaching adaptors 6a and 6b are fixed to the movable pole 12.

According to the second embodiment, the bolts B are directly screwed in the fixed pole 11 and the movable pole 12 in the thickness direction of the block-shape mechanical structure 1. The block-shape mechanical structure 1 is formed by boring a plate in the thickness direction thereof. Accordingly, as compared with a conventional structure where bolts are screwed in a direction perpendicular to the thickness direction, it is possible to reduce a strain in the block-shape mechanical structure 1. Also, the bolts B are screwed in the fixed pole 11 and the movable pole 12 four by four in the opposite directions. Therefore, loosening does not take place by a torque action in any direction.

In the embodiments described above, the present invention is applied to an electromagnetic force balance type electro-balance. The present invention can also be applied to an attaching adaptor attached to a fixed pole and movable pole in the load cell type balance having a Roberval mechanical member formed by boring a sheet of a raw material.

The disclosure of Japanese Patent Application No. 2003-386082 filed on Nov. 17, 2003 is incorporated in the application.

While the invention has been explained with reference to the specific embodiments of the invention, the explanation is illustrative and the invention is limited only by the appended claims.

1. A weight measuring device for measuring a weight, comprising:
a force measuring cell formed of a Roberval mechanism having a movable pole, a fixed pole, and two parallel beams connecting the movable pole and the fixed pole, at least one of the movable pole and the fixed pole having a plurality of holes formed in a thickness direction thereof,
adaptors attached to two sides of said one of the movable pole and the fixed pole in the thickness direction,
bolts and nuts engaging the bolts, said bolts passing through the holes and the adaptors and being tightened with the nuts, at least one of said bolts passing thorough the hole in a direction opposite to that of the other of the bolts, and
a receptacle plate attached to the movable pole for supporting a plate for placing the weight thereon.

2. A weight measuring device according to claim 1, wherein said adaptors are fixing adaptors attached to two sides of said fixed pole in the thickness direction for fixing the fixed pole to a base member.

3. A weight measuring device according to claim 1, wherein said adaptors are attaching adaptors attached to two sides of said movable pole in the thickness direction for attaching the movable pole to the receptacle plate.

4. A weight measuring device according to claim 1, wherein said Roberval mechanism has a block-shape mechanical structure with spaces therein by boring a sheet of a raw material in a thickness direction.

5. A weight measuring device for measuring a weight, comprising:
a force measuring cell formed of a Roberval mechanism having a movable pole, a fixed pole, and two parallel beams connecting the movable pole and the fixed pole, at least one of the movable pole and the fixed pole having a plurality of female screws formed at two sides thereof,
adaptors attached to the two sides of said one of the movable pole and the fixed pole,
bolts passing through the adaptors and being tightened with the female screws, and
a receptacle plate attached to the movable pole for supporting a plate for placing the weight thereon.

6. A weight measuring device according to claim 5, wherein said adaptors are fixing adaptors attached to two sides of said fixed pole for fixing the fixed pole to a base member.

7. A weight measuring device according to claim 5, wherein said adaptors are attaching adaptors attached to two sides of said movable pole for attaching the movable pole to the receptacle plate.

8. A weight measuring device according to claim 5, wherein said Roberval mechanism is a block-shape mechanical structure with spaces by boring a sheet of a raw material in a thickness direction.
